(19) United States
(12) Patent Application Publication
(10) Pub. No.: US 2025/0023925 A1
(43) Pub. Date: Jan. 16, 2025

(54) METHOD FOR ESTABLISHING VIRTUAL SUBROOM COMMUNICATION BETWEEN AT LEAST TWO MAIN ROOM PARTICIPANTS OF A VIRTUAL MAIN ROOM COMMUNICATION

(71) Applicant: Heinlein Support GmbH, Berlin (DE)

(72) Inventors: Peer HEINLEIN, Berlin (DE); Dennis KALBHEN, Potsdam (DE); Frederik SCHWAN, Darmstadt (DE)

(73) Assignee: Heinlein Support GmbH, Berlin (DE)

(21) Appl. No.: 18/698,848

(22) PCT Filed: Sep. 30, 2022
(86) PCT No.: PCT/DE2022/200230

§ 371 Date: Apr. 5, 2024

(30) Foreign Application Priority Data
Oct. 6, 2021 (DE) 10 2021 211 274.9

(51) Int. Cl. H04L 65/1089; H04L 12/18; H04L 65/1069; H04L 65/401; H04L 65/403

(52) U.S. Cl. CPC H04L 65/1089; H04L 12/1822; H04L 12/1831; H04L 65/1069; H04L 65/4015; H04L 65/403

(57) ABSTRACT

The present invention relates to a method for forming a virtual subroom communication (SRC) between at least two main room participants (MRP) of a virtual main room communication (MRC), comprising the following steps:
selecting at least two main room participants (MRP) of the main room communication (MRC) as subroom participants (SRP) for a subroom communication (SRC),
forming a multidirectional subroom audio connection (SRAC) between the at least two subroom participants (SRP) as a virtual subroom communication (SRC),
disconnecting the main room audio connection (MRA) of the subroom participants (SRP) to the main room communication (MRC),
forming a unidirectional main room transmission (MRT) of the main room communication (MRC) into the subroom communication (SRC).

The present invention relates to a method for forming a virtual subroom communication between at least two main room participants of a virtual main room communication as well as a corresponding computer program product for carrying out such a method.

It is known for virtual communications between participants to be carried out in the context of so-called video conferences. Usually, such video conferences can have a very large number of participants, who are connected to each other via an audio connection and a video connection. Such video conferences are used for the exchange of information between the individual participants, the conduct of so-called webinars or other virtual conferences, presentations and the like.

A disadvantage of the known video conferencing solutions is that, while it is in principle possible to split off individual participants into so-called video subrooms, these are then completely decoupled from the main conference with their video and audio. These are also known as breakout rooms. In other words, although the known video conferences offer the possibility for individual participants to decouple from a main room communication into a subroom and later rejoin the main room, they miss out on the ongoing communication in the main room during their participation in the subroom communication. Especially when trying to replicate real communications between a large number of people, this represents a decisive disadvantage, since each participant has to decide which communication to follow. In principle, it is only possible to select a single acoustic and/or visual communication that will be used for communication exchange.

It is therefore the object of the present invention to remedy, at least in part, the disadvantages described above. In particular, the object of the present invention is to allow intercommunication between individual participants without at the same time leaving the main communication, in a cost-effective and simple manner.

The above object is achieved by a method with the features of claim 1 and a computer program product with the features of claim 16. Further features and details of the invention are disclosed in the dependent claims, the description and the drawings. Naturally, features and details described in connection with the method according to the invention also apply in connection with the computer program product according to the invention and vice versa, so that, with regard to disclosure, mutual reference is or can always be made to the individual aspects of the invention.

According to the invention, a method for forming a virtual subroom communication between at least two main room participants of a virtual main room communication is proposed. Such a method comprises the following steps:
selecting at least two main room participants of the main room communication as subroom participants for a subroom communication,
forming a multidirectional subroom audio connection between the at least two subroom participants as a virtual subroom communication,
disconnecting the main room audio connection of the subroom participants to the main room communication,
forming a unidirectional main room transmission of the main room communication into the subroom communication.

A method according to the invention is a computer-implemented method that runs on corresponding terminal devices and/or corresponding central communication units. In other words, such a method can also be described as a video conferencing method or as a control method for a video conference. Such a method serves to make possible different levels of communication between the individual participants, i.e. in particular between the individual participant devices. Parallel communication between different participants with their participant devices is also preferred. The procedures regarding the parallelism of the individual communications are explained in more detail below.

The aim of the method according to the invention is for individual main room participants to be able to talk to each other without losing any information from the main room and the main room communication. In other words, a method according to the invention can make it possible for two or more main room participants to communicate with each other separately from the main room and at the same time continue to follow the main room communication. This can also be understood as digital whispering, as only the correspondingly selected main room participants can exchange information with each other for subroom communication, without having to leave the main room communication completely.

In order to make the effect of digital whispering described above possible for the participants of a video conference, a method according to the invention starts out from a main room communication. This main room communication is established by communication connections between the terminal devices of the individual main room participants, so that each main room participant receives the complete communication information of the main room communication on their terminal device, for example on a display device. In particular, this involves a main room audio connection and a main room video connection, so that the main room communication connects the individual main room participants with each other in the known manner of a video conference. It is irrelevant whether this involves an exchange between all main room participants or a hosted video conference, for example in the form of a conference, a panel discussion or a seminar.

If it is desired that individual main room participants can exchange ideas with each other without other main room participants being aware of the content of this exchange, with a method according to the invention a subroom communication can be formed for these selected main room participants. For this purpose, the at least two main room participants who wish to carry out this side communication are selected. This selection can be initiated by a main room participant, who selects one or more other main room participants accordingly on their participant device. In this way, the selected main room participants are identified as subroom participants for a subroom communication. Once this has been done, using a method according to the invention a multi-directional subroom audio connection between the selected subroom participants is formed as a virtual subroom communication. In reality, this is effected in that the corresponding participant devices of the selected subroom participants establish this audio connection with each other for the subroom communication, which is separate from the main room communication. In other words, an audio signal from a first subroom participant is now recorded by their participant device and transmitted via this subroom audio connection of the participant device, which is separate from the main room communication, to one or all other subroom participants, so that the latter pick up this audio signal.

In addition to the fact that this subroom audio connection now takes place in parallel with the main room communication, the main room audio connection of the subroom participants is disconnected from the subroom communication. This means that corresponding audio signals, e.g. words spoken by a subroom participant, are only transmitted to the selected other subroom participants via the selected subroom audio connection and are no longer introduced into the main room communication. In effect, this means that audio content of the subroom participants is shared exclusively among the participant devices of these subroom participants and the remaining main room participants do not receive this audio content, and consequently cannot listen to the content either. In this way, the digital whispering between the subroom participants, as defined according to the invention, is made available and limited to these subroom participants.

In order to ensure that the subroom participants do not have to leave the main room communication to participate in this digital whispering, and that there is no loss of information, in addition to this digital whispering a unidirectional main room transmission of the main room communication into the subroom communication is formed. Such a main room transmission can also be referred to as a unidirectional stream, so that this main room communication can still be followed by the subroom participants, either with a pure audio connection as a main room audio transmission or also, additionally, with a main room video transmission. In practice, this is effected in that the main room communication between the remaining main room participants is continued, and in addition the resulting data, i.e. audio data and/or video data, is converted into a main room transmission. In addition to the multidirectional distribution of the main room communication between the remaining main room participants, the main room transmission is now integrated, exclusively unidirectionally, into the subroom communication, for example, in the case of a video conferencing solution, being additionally superimposed on the subroom communication on the displays of the participant devices.

Ultimately, this means that the subroom participants can now exchange information with each other undisturbed via at least one subroom audio connection and at the same time can continue to follow the main room communication via the main room transmission. In other words, a situation is created which, for example in a plenary session involving a large number of people, allows individual main room participants to confidentially exchange “whispers” with each other, while at the same time they can continue to follow the content of the main room communication via the main room transmission. Another possible application is, in a seminar, the formation of a subroom communication, for example between a teacher and a student. This makes it possible for the teacher to communicate with a student through digital whispering in a subroom communication, for example to answer a question, without the other main room participants, i.e. the other students, listening in. The other main room participants don't pick up any of this. At the same time, however, the teacher, as main room participant and subsequent subroom participant, is able to follow the main room communication via the main room transmission, i.e. to follow the development of the main room communication of the remaining students as main room participants and, if necessary, to return to the main room communication. Of course, the two examples given above are only two possible application situations which do not limit the scope of protection of the present invention.

According to the invention, the selection steps can be carried out manually, automatically or in some other controlled manner. For example, a user can perform the selection manually on their participant device by clicking on corresponding checkboxes, so that the method can perform the selection based on this click information. Of course, automatic or semi-automatic selection based on attributes of main room participants is also possible within the scope of the present invention. It is also possible for two or more subroom communications to be formed in parallel, preferably parallel or overlapping in time. However, this is preferably limited to the effect that each main room participant can only participate as a subroom participant in a single subroom communication at any given time.

The subroom communications can be freely selected and opened, as well as closed, by the individual main room participants. However, it is also conceivable that only some main room participants, i.e. commentators or webinar leaders of main room communications, have the rights to open or close subroom communications in a method according to the invention.

It is also advantageous if, after the subroom communications have been formed, actions that the subroom participants perform on their participant devices are limited to the subroom communication. In an active subroom communication, actions such as, for example, a mute function, an unmute function, the sharing of screen content or the like are limited to this active subroom communication, so that even information content that goes beyond the pure subroom audio connection remains securely within the subroom communication and is preferably not transferred to the main room communication. In addition to a basic display of all main room participants during the course of the main room communication, it is advantageous if only the subroom participants are displayed on a display device of the participant device of the respective subroom participants during the formation of a subroom communication. It is also conceivable that, during an ongoing subroom communication, it remains possible for the individual subroom participants to contact each other and/or be contacted by the remaining main room participants. For example, remaining main room participants can call subroom participants back from the subroom communication, or at least contact these, via text messages or the like.

It can bring advantages if, in a method according to the invention, the main room transmission into the subroom communication comprises a main room audio transmission and/or a main room video transmission. Preferably, a combination of main room audio transmission and main room video transmission is provided. This makes it possible for the main room communication to be continued, for example in the form of a small transmission window on a display screen of a participant device of a subroom participant, and for both video information and audio information to be made available there via a corresponding audio output of the participant device of the subroom participants.

It is also advantageous if, in a method according to the invention, in addition to the main room audio connection, the main room video connection of the subroom participants to the main room communication is also disconnected. If the method according to the invention is a video conferencing solution, this means that the other main room participants are not only isolated from the audio connection in the subroom communication, but there is also no longer any video transmission from the subroom participants into the main room communication. For example, the subroom participants can be represented in the main room communication with a frozen still image, a black image with hatching or with status indicators, for example “not available”. Equally, the video transmission of the subroom participants to the main room can be set as if they had deactivated their own camera transmission in a regular manner. In other words, depending on the size of the main room communication, the subroom participants separated into the subroom communication are no longer recognisable as being available for the other main room participants.

It also brings advantages if, in a method according to the invention, the step of disconnection takes place before and/or during the formation of the multidirectional subroom audio connection. This avoids an overlapping parallel transmission in the subroom audio connection and the main room communication. Such an overlap would entail the risk that a subroom participant would mistakenly believe that they are already in the secured, exclusive subroom audio connection during this overlapping phase. If this disconnection from the main room communication takes place before or at the latest during the formation of the subroom audio connection, there is no longer an overlapping phase and, accordingly, maximum security for the confidentiality of the exchange of information in the subroom communication is ensured.

It is also advantageous if, in a method according to the invention, the main room transmission comprises a transmission volume which is preferably adjustable. This is particularly advantageous if the main room transmission comprises at least one main room audio transmission. The transmission volume is preferably always lower than the corresponding volume of the subroom audio connection and is preferably manually adjustable by the subroom participants on the respective participant device.

In the method according to the preceding paragraph, it may be advantageous if the transmission volume is lower than the volume of the subroom audio connection when the main room transmission is formed. This means that when the main room transmission is formed, it automatically fades, acoustically, into the background behind the volume of the subroom audio connection. For example, the ratio can be preset to 50% of the volume of the subroom audio connection. Of course, this ratio can be individually and specifically adaptable for the individual subroom participants.

It brings further advantages if, in a method according to the invention, the main room transmission represents a direct transmission of the main room communication. In other words, the audio information and the video information of the main room communication are converted into a direct stream which, as a transmission, represents the main room transmission. It is also possible that this main room transmission is based on the specific settings of the respective subroom participant, so that it is possible to specifically adapt the main room transmission to the wishes of the respective subroom participant on each participant device.

It is also advantageous if, in a method according to the invention, in addition to the subroom audio connection, a subroom video connection is formed for the subroom communication. To ensure additional information exchange, for example the sharing of screen information, video information or similar, the subroom video connection can extend the subroom communication. Of course, in particular the digital whispering which has already been explained several times is sufficient to bring the advantages of the invention simply with a subroom audio connection.

In addition, it is advantageous if, in a method according to the invention, the formation of the virtual subroom communication is suppressed if all main room participants are selected as subroom participants. In other words, this avoids the main room and thus the main room communication being emptied. If all main room participants were called to the same subroom, this would lead to a replacement of the main room communication by the subroom communication, or the result would be a suppression of the formation of the subroom communication. This can be supplemented in that all main room participants are prevented from being included in one, or even different, subroom communications at the same time.

It brings further advantages if, after the main room participants have been selected as subroom participants, these go through an admission step, preferably accepting and/or rejecting the selection. This means that the selection of a main room participant for subroom participation does not mean that this participant is automatically integrated into the subroom communication, but for example a window is displayed on a display device of their participant device in which they can either accept or reject this selection. Different method sequences may be applied. For example, if rejection does not occur within a predefined period of time this can result in automatic entry into the subroom communication.

It can also be advantageous if, in a method according to the invention, after a main room participant has been selected as a subroom participant, this participant is blocked from further selection as a subroom participant. This means that the main room participant can only be active in a single subroom communication at a given time. If this is the case and this subroom participant is at this point selected by another main room participant for a different subroom communication, this will be blocked in a method according to the invention. This means that on this second subsequent selection the selecting main room participant is for example provided with a display indicating that this main room participant is not currently available for a subroom communication.

It can also be advantageous if, in a method according to the invention, the subroom communication blocks recording. In order to further strengthen the relationship of trust in the subroom communication between the subroom participants, it can be advantageous if, from a technical viewpoint, recording options are not available in the subroom communication. In particular, such recordings can be actively blocked, maximising the confidentiality of the subroom communication.

It is also advantageous if, in a method according to the invention, following the termination of a subroom communication the subroom participants of this subroom communication are saved for the history of the main room communication. If a main room communication runs over a longer period of time, for example several hours, it may happen that several main room participants want to exchange information in a subroom communication several times within the main room communication that lasts several hours. In order to increase the convenience of using a method according to the invention, such a method can save the composition of past subroom communications with regard to the corresponding subroom participants and display these again to the respective main room participant on later activation and request for selection of new subroom communications. This greatly simplifies formation and initiation in a method according to the invention. Of course, suggestions for the selection for the individual main room participants for subroom communications can also be the subject of the present invention, if for example a probability is recognised, on the basis of attributes of the main room participants or the like, that these may be desired subroom participants for the respective selecting main room participant.

It is also advantageous if, in a method according to the invention, to make an addition to a formed subroom communication, at least one other main room participant is selected as a further subroom participant. For example, it can happen that while a subroom communication is in progress, the desire arises to add a main room participant who has not yet joined in this subroom communication. This makes it possible for a main room participant from the remaining main room communication to be added to an ongoing subroom communication without having to form a new subroom communication, in the same way as was the case for the existing subroom participants when the subroom communication was formed for the first time. This also makes it possible to provide greater flexibility and, in particular, also allows individual subroom participants to specifically leave the subroom communication.

In addition, it can be advantageous if, in a method according to the invention, the subroom communication comprises a subroom encryption which differs from a main room encryption. Beside the fact that the technical separation between subroom communication and main room communication in itself prevents active information from the subroom communication from reaching the remaining main room participants, there may however be a risk that main room participants will try, with criminal intent, to intercept the data from the subroom communication so as to be able evaluate it themselves. In order to ensure that such criminal effects are also prevented with a high degree of effectiveness, thus increasing confidentiality in the subroom communication, encryption systems can be used which not only protect the entire main room communication against external attacks, but also provide internal security. For this purpose, encryption systems, in particular identical encryption systems, are used for the subroom communication and main room communication, although the two encryptions differ from each other. In other words, only the subroom participants have code access to the subroom communication, so that even if data is shared between the subroom communication and main room communication, any criminal accessing of the subroom communication by main room participants does not enable them to decrypt the content of the subroom communication.

The subject matter of the present invention also includes a computer program product comprising instructions which, when the program is executed by a computer, cause the computer to carry out the steps of a method according to the invention. Thus, a computer program product according to the invention brings the same advantages as have been explained in detail with reference to a method according to the invention. Preferably, the computer program product runs on a communication network and on participant devices within that communication network, so that a corresponding audio connection and/or video connection is possible via audio devices or display devices on participant devices.

Further advantages, features and details of the invention are explained in the following description, in which embodiments of the invention are described in detail with reference to the drawings. The features mentioned in the claims and in the description may be essential to the invention individually or in any combination. In each case schematically:

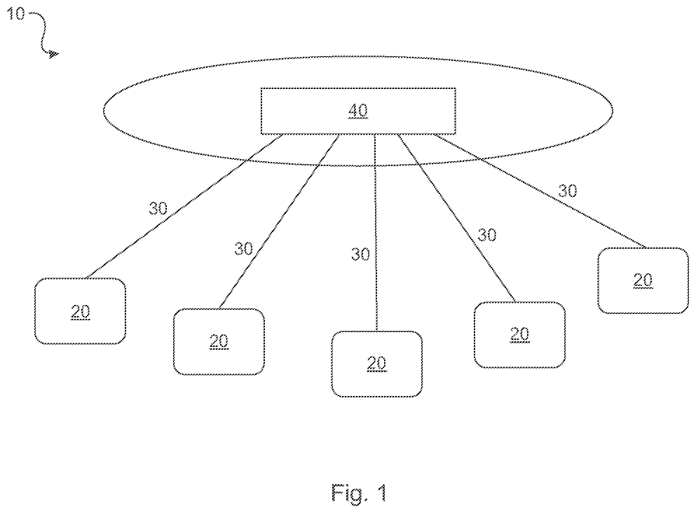

FIG. 1 shows an example of a communication network for a method according to the invention,

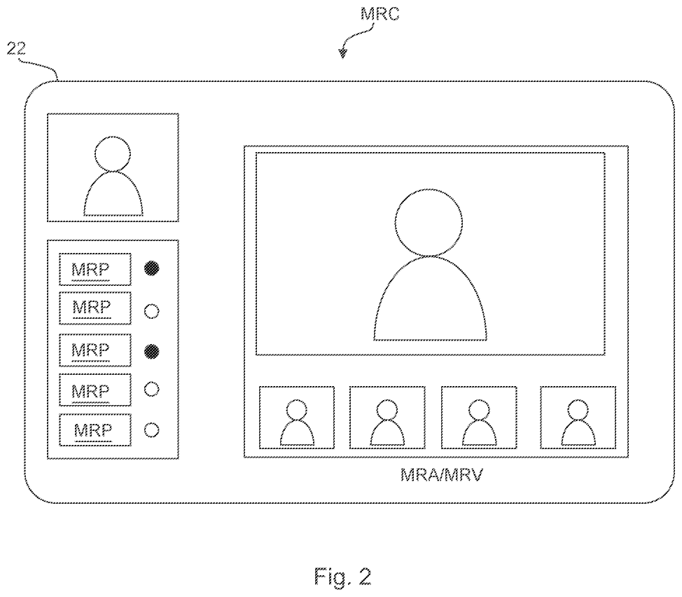

FIG. 2 shows a first step of a method according to the invention,

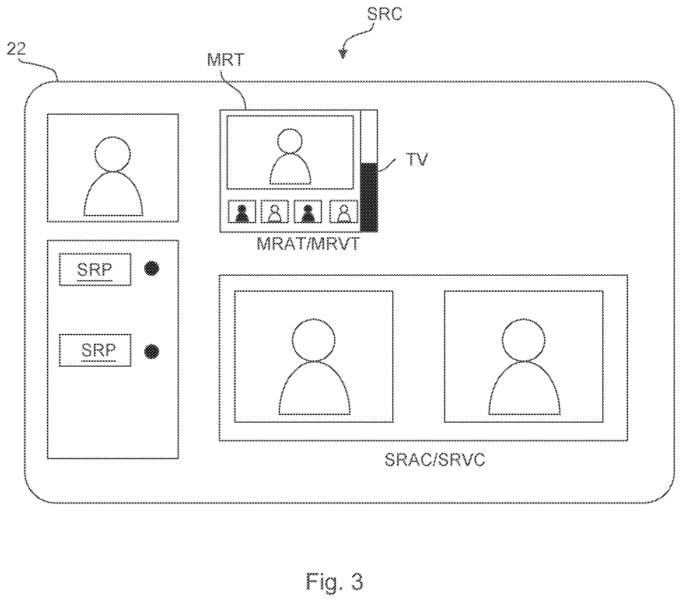

FIG. 3 shows a further step of a method according to the invention,

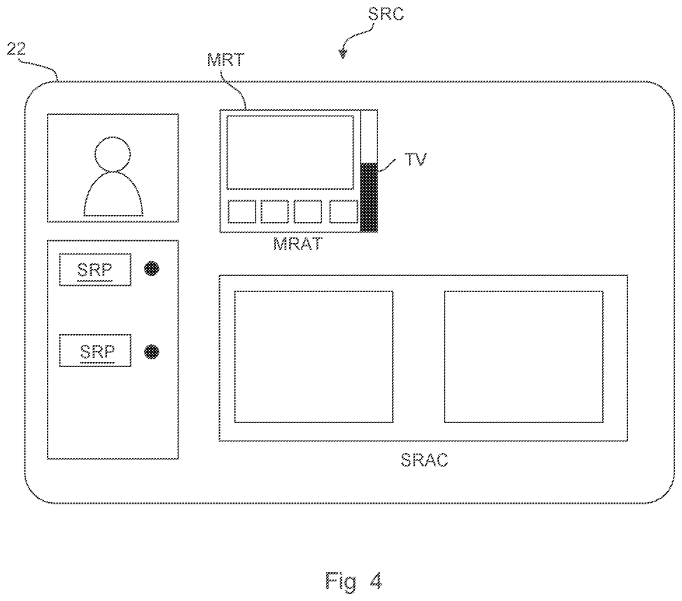

FIG. 4 shows another further step of a method according to the invention,

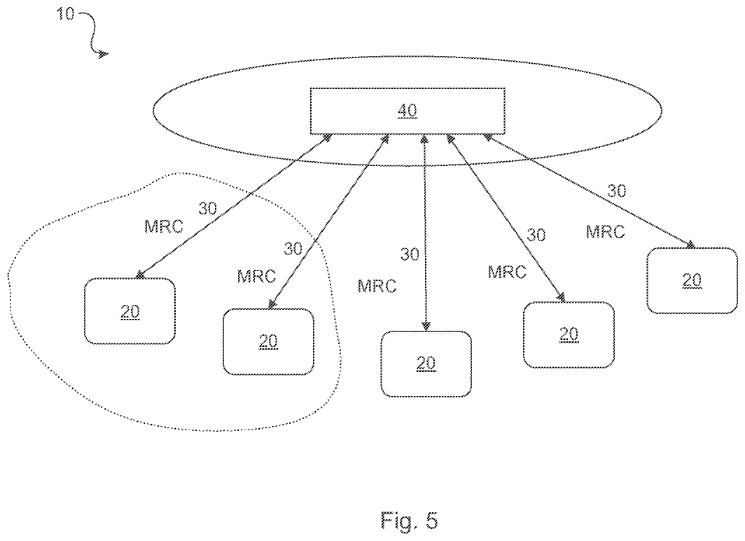

FIG. 5 shows a possible implementation of the method in a communication network,

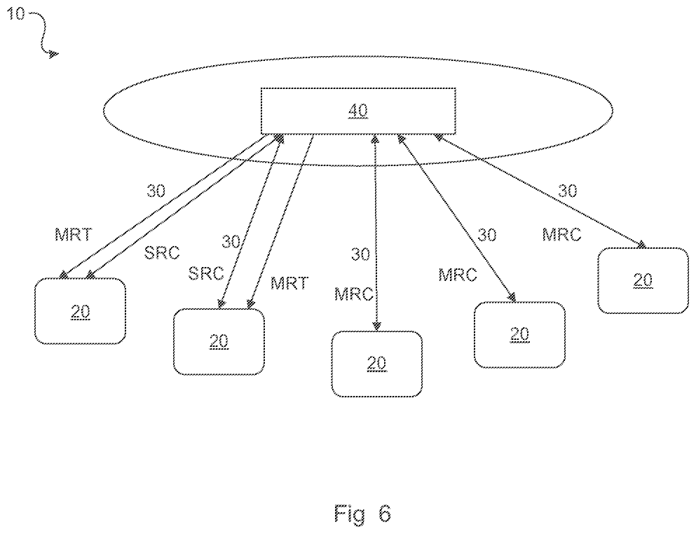

FIG. 6 shows a further implementation of the method in the communication network,

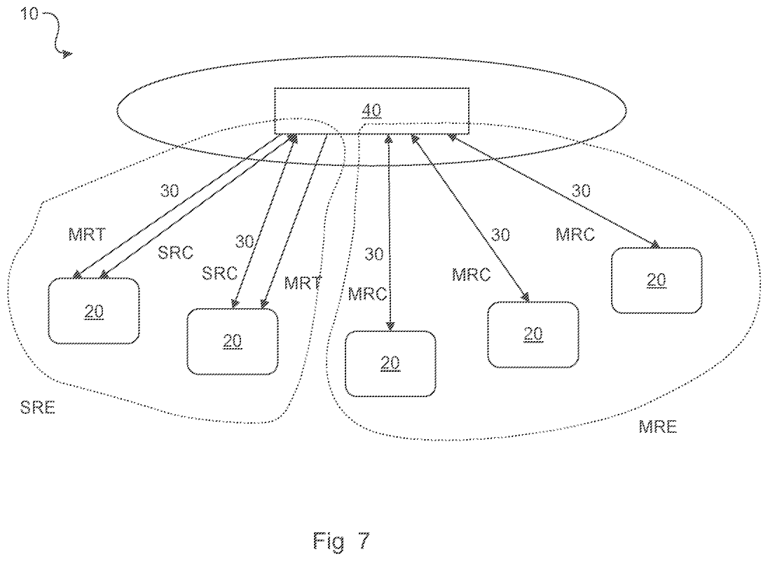

FIG. 7 shows a further implementation in a communication network.

FIG. 1 shows schematically a structure that can be described as a communication network 10. This can be a wired local version, but can of course also involve partially wireless and geographically higher-level embodiments. A communication distributor 40, for example in the form of a server device, is provided centrally. This comprises communication connections 30 to a large number of participant devices 20, whereby for each participant device a participant is identified as main room participant MRP and/or subroom participant SRP. FIG. 1 thus shows a star-shaped embodiment of a communication possibility in a communication network 10 on which a method according to the invention can run. The method according to the invention can be implemented as a computer program product, both centrally in the communication distributor 40 as well as at least partially locally in the participant devices 20.

FIGS. 2 to 4 show possible representations on display devices 22 of the participant device 20 in the communication network 10 according to FIG. 1. For the sake of simplicity and clarity, a method according to the invention is shown here schematically in the form of a video conferencing solution.

FIG. 2 shows a situation that can occur in video conferences. Here, a main room communication MRC is taking place, whereby a main room audio connection MRA and a main room video connection MRV take place simultaneously on the display device 22, in this case a display. Here, a speaker-centred representation is selected, i.e. a large video transmission shows the currently active speaker and, below this, small video transmissions show the other main room participants MRP. On the left is a list of the main room participants MRP which provides selection options with round so-called checkboxes.

FIG. 2 already shows the main room participants MRP selected in the first step of a method according to the invention, i.e. two main room participants MRP are selected here for a subroom communication SRC. Following this selection step, an admission step can take place, which allows the respective main room participant MRP to accept and/or reject this selection. As soon as this is done, a subroom communication SRC is formed, as shown for example in FIG. 3. Here, the subroom communication SRC is also provided with a subroom audio connection SRAC and a subroom video connection SRVC, so that, within the subroom communication SRC, two subroom participants SRP can talk to each other and exchange information here via video. However, this subroom communication SRC is not disconnected from the ongoing main room communication MRC. Rather, the main room transmission MRT, in which a transmission of the ongoing main room communication MRC takes place, is also superimposed at the top of the display 22, in a small box. For this purpose, a main room audio transmission MRAT and a main room video transmission MRVT are carried out here.

As can be seen from FIG. 3, the two subroom participants SRP are shown here blacked out, so that they are recognisable to the other main room participants MRP as non-active participants of the main room communication MRC. Also, to improve clarity in the main room transmission MRT, the display of the passive participants can be dispensed with and, in particular, only the currently active speaker displayed. In this case, the representation of the subroom participant SRP would appear blacked out in the corresponding representations on the participant devices 20 of the other main room participants MRP.

To make it easier for the subroom participants SRP to concentrate on the subroom communication, a transmission volume TV is shown here as a volume bar for the main room transmission MRT. Here, this is located at about the middle level, i.e. for example at about 50% of the volume of the subroom communication SRC. Of course, an adjustability can be provided here for each individual subroom participant SRP on their participant device 20.

FIG. 4 shows a further variant of the embodiment of the subroom communication SRC. However, in this case the subroom communication SRC is limited to a subroom audio connection SRAC. In addition, the main room transmission MRT is also limited exclusively to audio signals with a main room audio transmission MRAT. Of course, combinations of the two variants according to FIG. 3 and FIG. 4 are also possible, so that an exclusive audio exchange of a subroom communication SRC can be combined with an audio and video exchange in the main room transmission MRT, just as, conversely, a pure audio transmission in the main room transmission MRT can be accompanied by an audio and video transmission of a subroom communication SRC.

FIG. 5 shows schematically the communication situation in the communication network 10 using such a method. For example, the main room communication MRC takes place multi-directionally while the main room communication MRC is running, as shown in FIG. 5. Each participant device 20 sends the locally generated data from the respective main room participant MRP to the central communication distributor 40, which in turn distributes this data to the other main room participants MRP via the communication connections 30. This multi-directional connection corresponds to known video conferencing solutions. In FIG. 5, the two left-hand participant devices 20 of main room participants MRP are selected for a subroom communication SRC.

After the selection step of FIG. 5, in FIG. 6 the subroom communication SRC is established as a bidirectional communication between the two corresponding participant devices 20 on the left. These form the subroom communication SRC, and only exchange their data with each other, i.e. between the two participant devices 20 of the subroom participants SRP. This bidirectional exchange can take place directly, as a so-called peer-to-peer connection between the two participant devices 20 or, as shown in FIG. 6, via the communication distributor 40. In addition, a disconnection from the main room communication MRC takes place, so that data cannot be transferred from the subroom communication SRC to the main room communication MRC, nor can data reach the subroom communication SRC from the main room communication MRC. In order nonetheless to enable the participant devices 20 of the subroom participants SRP to participate in the main room communication MRC, the ongoing main room communication MRC is translated into a main room transmission MRT, which is however transmitted exclusively unidirectionally from the communication distributor 40 to the participant device 20 of the subroom participant SRP. The separation between the subroom communication SRC and the main room communication MRC, and thus the protection of the data exchange within the subroom communication SRC, is clearly visualised here.

In order to further improve this protection concept, in addition to the pure separation of the data, a further additional encryption is shown in FIG. 7. As an alternative to the illustration in FIG. 7, the main room encryption MRE can also be retained for all subroom participants SRP, so that the subroom communication SRC is established with its own subroom encryption SRE in parallel with the main room encryption MRE. The appropriate encryption is used depending on the group of participants to which data is sent or from which group of participants data is received because, although the data is separated between the main room communication MRC and the subroom communication SRC, if it is not implemented as a peer-to-peer connection it is still routed via the same communication distributor 40. This could lead to a situation in which the content of the subroom communication SRC could, with criminal intent, be evaluated and analysed by other main room participants MRP. To avoid this, a subroom encryption SRE and a main room encryption MRE are designed differently from each other, so that even if the data of the subroom communication SRC is read by other main room participants MRP with criminal intent, as described above, they will not succeed in decrypting the content of this data.

The above explanation of the embodiments describes the present invention exclusively in the context of examples. Of course, individual features of the embodiments can, if technically expedient, be freely combined with each other without departing from the scope of the present invention.

### LIST OF REFERENCE SIGNS

10 communication network

20 participant device

22 display device

30 communication connection

40 communication distributor

SRC subroom communication

SRP subroom participant

SRAC subroom audio connection

SRVC subroom video connection

SRE subroom encryption

MRC main room communication

MRP main room participant

MRA main room audio connection

MRV main room video connection

MRE main room encryption

MRT main room transmission

MRAT main room audio transmission

MRVT main room video transmission

TV transmission volume

1. Method for forming a virtual subroom communication (SRC) between at least two main room participants (MRP) of a virtual main room communication (MRC), comprising the following steps:
selecting at least two main room participants (MRP) of the main room communication (MRC) as subroom participants (SRP) for a subroom communication (SRC),
forming a multidirectional subroom audio connection (SRAC) between the at least two subroom participants (SRP) as a virtual subroom communication (SRC),
disconnecting the main room audio connection (MRA) of the subroom participants (SRP) to the main room communication (MRC),
forming a unidirectional main room transmission (MRT) of the main room communication (MRC) into the subroom communication (SRC).

2. Method according to claim 1, wherein the main room transmission (MRT) into the subroom communication (SRC) comprises a main room audio transmission (MRAT) and/or a main room video transmission (MRVT).

3. Method according to claim 1, wherein in addition to the main room audio connection (MRA), the main room video connection (MRA) of the subroom participants (SRP) to the main room communication (MRC) is also disconnected.

4. Method according to claim 1, wherein the step of disconnection takes place before and/or during the formation of the multidirectional subroom audio connection (SRAC).

5. Method according to claim 1, wherein the main room transmission (MRT) has a transmission volume (TV) which preferably is adjustable.

6. Method according to claim 5, wherein when forming the main room transmission (MRT), the transmission volume (TV) is less than the volume of the subroom audio connection (SRAC).

7. Method according to claim 1, wherein the main room transmission (MRT) represents a direct transmission of the main room communication (MRC).

8. Method according to claim 1, wherein in addition to the subroom audio connection (SRAC), a subroom video connection (SRVC) is formed for the subroom communication (SRC).

9. Method according to claim 1, wherein the formation of the virtual subroom communication (SRC) is suppressed if all main room participants (MRP) are selected as subroom participants (SRP).

10. Method according to claim 1, wherein after the main room participants (MRP) have been selected as subroom participants (SRP), they go through an admission step, preferably accepting and/or rejecting this selection.

11. Method according to claim 1, wherein after a main room participant (MRP) has been selected as a subroom participant (SRP), the latter is blocked from further selection as a subroom participant (SRP).

12. Method according to claim 1, wherein the subroom communication (SRC) blocks recording.

13. Method according to claim 1, wherein following the termination of a subroom communication (SRC), the subroom participants (SRP) of this subroom communication (SRC) are saved for the history of the main room communication (MRC).

14. Method according to claim 1, wherein to make an addition to a formed subroom communication (SRC), at least one other main room participant (MRP) is selected as an additional subroom participant (SRP).

15. Method according to claim 1, wherein the subroom communication (SRC) has a subroom encryption (SRE) which differs from a main room encryption (MRE).

16. Computer program product comprising instructions which, when the program is executed by a computer, cause the computer to carry out the steps of a method with the features of claim 1.
